(19) United States
(12) Patent Application Publication
(10) Pub. No.: US 2010/0228993 A1
(43) Pub. Date: Sep. 9, 2010

(54) USB interface apparatus and USB packet transmitting/receiving method

(75) Inventor: Takayuki Suzuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/659,210

(22) Filed: Mar. 1, 2010

(30) Foreign Application Priority Data
Mar. 6, 2009 (JP) 53590/2009

(51) Int. Cl. H03M 13/09; G06F 11/10; H04L 9/00; G06F 13/38

(52) U.S. Cl. 713/189; 714/807; 714/E11.032; 710/63

(57) ABSTRACT

A USB interface apparatus is provided in electronic equipment on a USB packet transmission side, and includes a conversion unit for converting CRC object data which is data contained in a field subjected to CRC calculation in a USB packet, based on a predetermined rule corresponding to reverse conversion of conversion to be performed on the CRC object data by destination electronic equipment; a CRC calculation unit for calculating a CRC of CRC object data obtained before conversion by the conversion unit; and a packet generation unit for generating a USB packet containing data converted by the conversion unit and the CRC calculated by the CRC calculation unit.

### FIELD OF THE INVENTION

The present invention relates to a USB interface apparatus and a USB packet transmitting/receiving method, and in particular, relates to a USB interface apparatus having a security function and a USB packet transmitting/receiving method thereof.

### BACKGROUND OF THE INVENTION

A USB (Universal Serial Bus) interface offers high convenience, and therefore is standard equipment on many personal computers, so that various kinds of devices can be connected to personal computers through USB. Further, USB is equipped not only in personal computers but also in digital TV, car navigation systems, etc., and is also used for data transfer without the mediation of a personal computer.

However, the USB specification does not have a security function in the standard, so that there is a problem that a USB device that does not originally have a separate security function can easily be fraudulently used by malicious users. As an example, data stored in a USB device can be fraudulently read and written. Further, an unexpected data (e.g., computer virus) can be fraudulently copied and executed from an unauthorized USB device.

Japanese Unexamined Patent Application Publication No. 2003-186819 describes a computer system having a USB device with a security function. Referring to FIG. 1 of Japanese Unexamined Patent Application Publication No. 2003-186819, hardware and software for implementing an authentication function is added to a USB host 10 and a USB device 20, thereby enhancing a security function. When the USB host 10 detects connection of the USB device 20, information necessary for data transfer is exchanged, and then regular USB communication (enumeration phase “ENUMERATION”) is enabled. With the authentication function added to the enumeration phase, data transfer is enabled only if the authentication is passed.

Newly added hardware and software in the computer system described in Japanese Unexamined Patent Application Publication No. 2003-186819 are as follows. Referring to FIG. 1 of Japanese Unexamined Patent Application Publication No. 2003-186819, client software 11 and an ID storage unit 16 are added to the USB host 10. On the other hand, a security interface 24, an interface control unit 25, an interface select switch 26, a security function select switch 28; and a security function status display unit 29 are added to the USB device 20.

Operations of the computer system described in Japanese Unexamined Patent Application Publication No. 2003-186819 are as follows. Referring to FIG. 1 of Japanese Unexamined Patent Application Publication No. 2003-186819,

[1] A common value is registered in the ID storage unit 16 of the USB host 10 and an ID storage unit 27 of the USB device 20.
[2] When the USB device 20 is connected, the USB host 10 detects connection (“CONNECT”) of the USB device 20. The USB device 20 sets the interface control unit 25 such that the security interface 24 returns a descriptor.
[3] The USB host 10 requests the descriptor of the security interface 24 from the USB device 20.
[4] The USB device 20 returns the descriptor of the security interface 24 to the USB host 10.
[5] After the USB host 10 acquires the descriptor of the security interface 24, the USB host 10 requests an ID (value in the ID storage unit) from the USB device 20.
[6] The USB device 20 returns the value registered in the ID storage unit 27 of the USB device 20 to the USB host 10.
[7] The USB host 10 authenticates the ID transmitted from the USB device 20.
[8] If the authentication is passed, the USB host 10 issues a command for enabling a peripheral equipment interface 21 to the USB device 20. Thereby, in the USB device 20, the peripheral interface 21 is selected by the interface control unit 25. After this, the phase is shifted to the regular USB enumeration phase.

The “regular USB enumeration phase” refers to “enumeration with the peripheral equipment interface”. On the other hand, if the authentication is not passed, the phase is not shifted to the regular USB enumeration phase, so that the USB device 20 is disabled.

### SUMMARY OF THE INVENTION

The present inventors have made the following analysis.

In the computer system described in Japanese Unexamined Patent Application Publication No. 2003-186819, enumeration with the peripheral equipment interface 21 is enabled after the authentication. Accordingly, the USB device 20 needs to include the security interface 24 for transmitting/receiving the descriptor before the authentication and the interface control unit 25 for switching between two interfaces. Since the switching between the interfaces is performed by the USB host 10 in accordance with the authentication result, software for implementing this function needs to be added to the USB host 10. Further, the authentication function of checking the value registered in the ID storage unit 16 of the USB host 10 against the value obtained from the USB device 20 needs to be provided in the USB host 10.

Further, the ID is requested and transmitted in the enumeration phase with the security interface 24. However, this operation is not a standard device request; therefore, a driver other than a driver for a standard USB device is required. If the USB host 10 conforms to the host controller interface specifications such as OHCI/EHCI, the standard driver can be used therefor. If the USB device 20 is also of a standard class, the standard driver can be used therefor. If the standard driver can be used, it is possible to reduce software development cost.

However, in the case where the authentication function is implemented in a USB upper layer (software hierarchy) as in the computer system described in Japanese Unexamined Patent Application Publication No. 2003-186819, software for implementing the above function other than the standard software is required. Accordingly, the advantage of using the standard software is impaired, and there is a problem that the development of special software increases the development and test period and the development cost.

Therefore, it is an object of the invention to achieve a USB security function with a simple software or hardware configuration.

A USB interface apparatus according to a first aspect of the invention is a USB interface apparatus provided in electronic equipment on a USB packet transmission side, and includes a conversion unit for converting CRC (Cyclic Redundancy Check) object data which is data contained in a field subjected to CRC calculation in a USB packet, based on a predetermined rule corresponding to reverse conversion of conversion to be performed on the CRC object data by destination electronic equipment; a CRC calculation unit for calculating a CRC of CRC object data obtained before conversion by the conversion unit; and a packet generation unit for generating a USB packet containing data converted by the conversion unit and the CRC calculated by the CRC calculation unit.

A USB interface apparatus according to a second aspect of the invention is a USB interface apparatus provided in an electronic equipment on a USB packet reception side, and includes an extraction unit for extracting CRC object data which is data contained in a field subjected to CRC calculation in a USB packet and a CRC from the USB packet; a conversion unit for converting the CRC object data extracted by the extraction unit, based on a predetermined rule corresponding to reverse conversion of conversion performed on the CRC object data by source electronic equipment; a CRC calculation unit for calculating a CRC of CRC object data obtained after conversion by the conversion unit; and a comparison unit for comparing the CRC extracted by the extraction unit and the CRC calculated by the CRC calculation unit.

Electronic equipment according to a third aspect of the invention includes the USB interface apparatus.

A USB communication system apparatus according to a fourth aspect of the invention includes such electronic equipment.

A USB packet transmitting method according to a fifth aspect of the invention includes the steps of converting CRC object data which is data contained in a field subjected to CRC calculation in a USB packet, based on a predetermined rule corresponding to reverse conversion of conversion to be performed on the CRC object data by destination electronic equipment; calculating a CRC of CRC object data obtained before conversion in the conversion step; and generating and transmitting a USB packet containing data converted in the conversion step and the CRC calculated in the CRC calculation step.

A USB packet receiving method according to a sixth aspect of the invention includes the steps of receiving a USB packet; extracting CRC object data which is data contained in a field subjected to CRC calculation in the received USB packet and a CRC from the USB packet; converting the CRC object data extracted in the extraction step, based on a predetermined rule corresponding to reverse conversion of conversion performed on the CRC object data by source electronic equipment; calculating a CRC of CRC object data obtained after conversion in the conversion step; and comparing the CRC extracted in the extraction step and the CRC calculated in the CRC calculation step.

A USB packet communication method according to a seventh aspect of the invention includes each step in the USB packet transmitting method and each step in the USB packet receiving method.

A program according to a eighth aspect of the invention allows a computer on a USB packet transmission side to execute the steps of converting CRC object data which is data contained in a field subjected to CRC calculation in a USB packet, based on a predetermined rule corresponding to reverse conversion of conversion to be performed on the CRC object data by destination electronic equipment; calculating a CRC of CRC object data obtained before conversion in the conversion step; and generating and transmitting a USB packet containing data converted in the conversion step and the CRC calculated in the CRC calculation step.

A program according to a ninth aspect of the invention allows a computer on a USB packet reception side to execute the steps of receiving a USB packet; extracting CRC object data which is data contained in a field subjected to CRC calculation in the received USB packet and a CRC from the USB packet; converting the CRC object data extracted in the extraction step, based on a predetermined rule corresponding to reverse conversion of conversion performed on the CRC object data by source electronic equipment; calculating a CRC of CRC object data obtained after conversion in the conversion step; and comparing the CRC extracted in the extraction step and the CRC calculated in the CRC calculation step.

In accordance with the USB interface apparatus, the USB packet transmitting/receiving method, and the program according to the invention, it is possible to achieve a USB security function with a simple software or hardware configuration.

### BRIEF DESCRIPTION OF THE DRAWINGS

FIG. 1 is a block diagram showing the configuration of a USB interface apparatus according to a first embodiment of the present invention;

FIG. 2 is a block diagram showing the configuration of a USB interface apparatus according to a second embodiment of the invention;

FIG. 3 is a block diagram showing the configuration of USB interface apparatuses according to a third embodiment of the invention;

FIG. 4 is a block diagram showing the configuration of a USB packet processing circuit (SIE) according to Example 1.

FIG. 5 is a diagram showing the configuration of a USB token packet;

FIG. 6 is a diagram showing the configuration of a USB data packet;

FIG. 7 is a block diagram showing the configuration of USB interface apparatuses according to Example 2 of the invention;

FIG. 8 is a flowchart of IN-direction USB transaction processing by the USB interface apparatuses according to Example 2 of the invention;

FIG. 9 is a block diagram showing the configuration of USB interface apparatuses according to Example 3 of the invention;

FIG. 10 is a flowchart of IN-direction USB transaction processing by the USB interface apparatuses according to Example 3 of the invention;

FIG. 11 is a flowchart of OUT-direction USB transaction processing by the USB interface apparatuses according to Example 3 of the invention; and

FIG. 12 is a block diagram showing the configuration of USB interface apparatuses according to Example 4 of the invention.

### DETAILED DESCRIPTION OF THE PREFERRED EMBODIMENTS

### First Embodiment

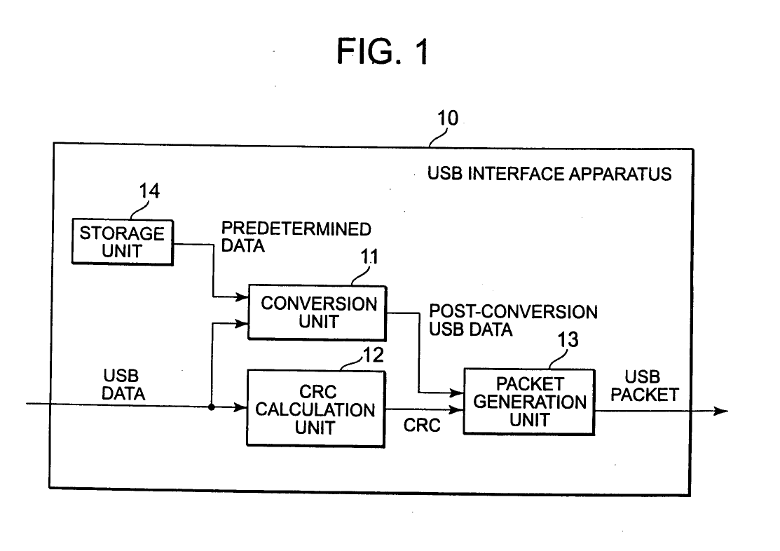

A USB interface apparatus according to the first embodiment of the present invention will be described with reference to a drawing. FIG. 1 is a block diagram showing the configuration of the USB interface apparatus according to the first embodiment of the invention and provided in electronic equipment on a USB packet transmission side. Referring to FIG. 1, the USB interface apparatus 10 includes a conversion unit 11, a CRC calculation unit 12, and a packet generation unit 13.

The conversion unit 11 converts CRC object data which is data contained in a field subjected to CRC calculation in a USB packet, based on a predetermined rule corresponding to reverse conversion of conversion to be performed on the CRC object data by destination electronic equipment.

The CRC calculation unit 12 calculates a CRC of CRC object data obtained before conversion by the conversion unit 11.

The packet generation unit 13 generates a USB packet containing the data converted by the conversion unit 11 and the CRC calculated by the CRC calculation unit 12.

### Second Embodiment

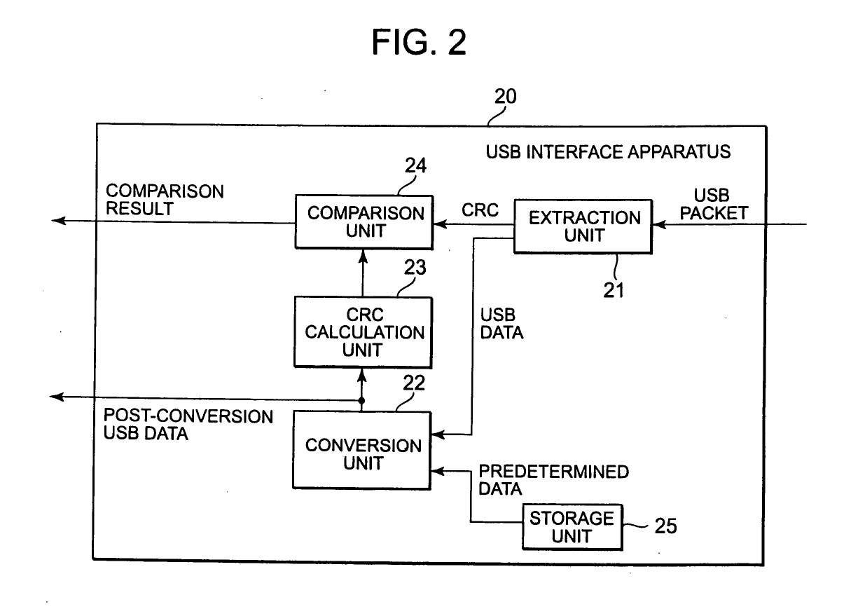

A USB interface apparatus according to the second embodiment of the invention will be described with reference to a drawing. FIG. 2 is a block diagram showing the configuration of the USB interface apparatus according to the second embodiment of the invention and provided in electronic equipment on a USB packet reception side. Referring to FIG. 2, the USB interface apparatus 20 includes an extraction unit 21, a conversion unit 22, a CRC calculation unit 23, and a comparison unit 24.

The extraction unit 21 extracts CRC object data which is data contained in a field subjected to CRC calculation in a USB packet and a CRC from the USE packet.

The conversion unit 22 converts the CRC object data extracted by the extraction unit 21, based on a predetermined rule corresponding to reverse conversion of conversion performed on the CRC object data by source electronic equipment.

The CRC calculation unit 23 calculates a CRC of CRC object data obtained after conversion by the conversion unit 22.

The comparison unit 24 compares the CRC extracted by the extraction unit 21 and the CRC calculated by the CRC calculation unit 23.

### Third Embodiment

The conversion by the conversion unit 11 in the USB interface apparatus 10 according to the first embodiment and the conversion by the conversion unit 22 in the USB interface apparatus 20 according to the second embodiment based on the predetermined rule may be performed using predetermined data shared between the source device and the destination device.

Further, the predetermined data may be a predetermined bit string, and the predetermined rule may be an exclusive OR operation performed on a bit-by-bit basis between the predetermined bit string and the CRC object data.

Furthermore, the predetermined data may be a common key of a common key encryption, and the predetermined rule may be encryption or decode of the CRC object data on the basis of the common key.

The USB interface apparatus 10 or the USB interface apparatus 20 may further include a storage unit 14 or a storage unit 25 for storing the predetermined data.

Further, the USB packet is preferably a token packet or a data packet in USB communication.

Electronic equipment preferably includes the USB interface apparatus 10 and/or 20. Further, a USB communication system apparatus preferably includes such electronic equipment.

### Fourth Embodiment

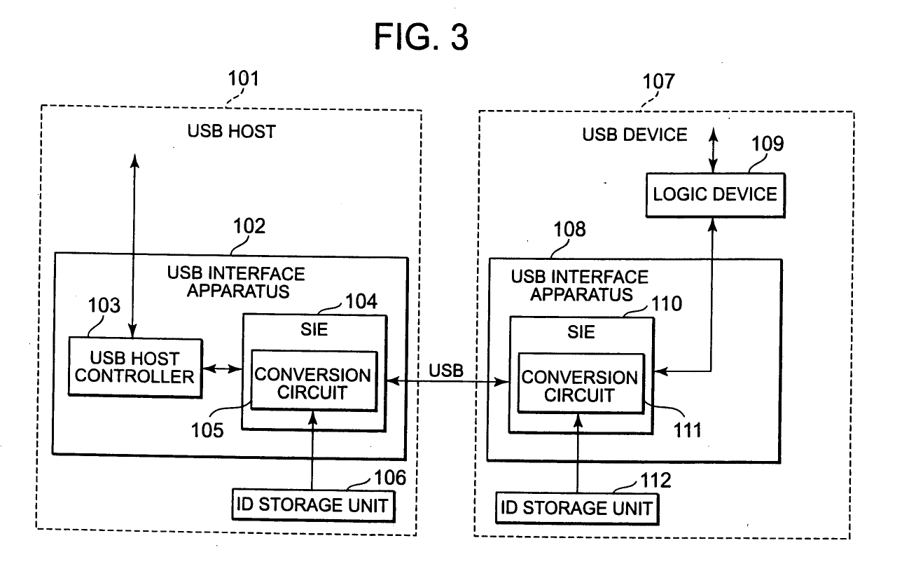

USB interface apparatuses according to the fourth embodiment of the invention will be described with reference to a drawing. Referring to FIG. 3, a USB interface apparatus 102 of a USB host 101 and a USB interface apparatus 108 of a USB device 107 have conversion circuits 105 and 111 for converting transmission data in accordance with values stored in ID storage units 106 and 112 respectively, thereby achieving a security function.

In the computer system described in Japanese Unexamined Patent Application Publication No. 2003-186819, the authentication function is added to improve USB security. On the other hand, in the present invention, in USB communication between a USB host and a USB device that do not have a common ID (value in the ID storage units 106 and 112), a CRC error occurs so that the USB communication is not established, thereby improving the security. In this embodiment, the units that need to be added to a standard USB system are the conversion circuits 105 and 111 and the ID storage units 106 and 112.

As an example, the conversion circuits 105 and 111 can be achieved with a simple circuit configuration such as XOR circuits. In the case where ID registration into the ID storage units 106 and 112 is implemented by software, software for implementing such a function is required. However, processing in an upper layer than the USB interface apparatuses 102 and 108 of the USB host 101 and the USB device 107 is standard USB processing, and therefore can be implemented based only on the standard software.

Thus, according the USB interface apparatuses of this embodiment, the security function can be achieved by adding simple hardware (circuits) and software.

### Example 1

Example 1 of the invention will be described with reference to drawings. In USB communication, the transaction composed of a token packet, a data packet, and a handshake packet is repeated.

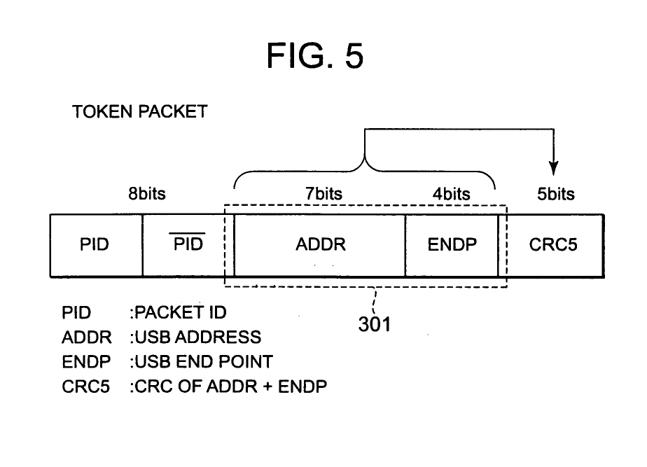

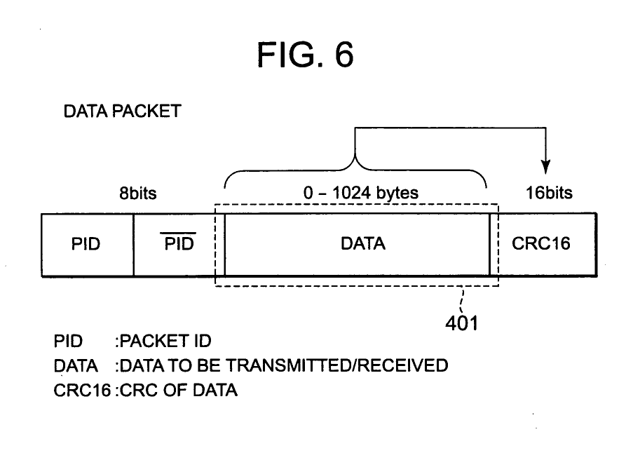

FIG. 5 is a diagram showing the configuration of a USB token packet. FIG. 6 is a diagram showing the configuration of a USB data packet. Referring to FIGS. 5 and 6, the token packet and the data packet contain CRCs of respective data (hereinafter referred to as “CRC object data”) stored in specific fields 301 and 401 (hereinafter referred to as “CRC object fields”) in the packets.

A CRC is calculated from CRC object data on a transmission side of a packet, and appended to the packet for transmission. That is, the CRC appended to the USB packet is a value calculated from the CRC object data of the packet. On a reception side, a CRC of the CRC object data is recalculated, and the recalculated CRC is checked against the CRC appended to the packet. That is the recalculated CRC is compared the CRC appended to the packet. If the comparison result indicates a match, the packet is received normally. If the comparison result indicates a mismatch, the packet is discarded. This is a summary of regular USB communication.

On the other hand, in this example, the relationship between CRC object data in a transmission packet and a CRC appended to the packet differs from that of the packet in the above-described regular USB communication. That is, the CRC appended to the transmission packet is a CRC calculated from the CRC object field obtained before conversion by the conversion circuit, and the CRC object data is data obtained after CRC conversion. In this example, if the CRC object data converted on the transmission side cannot be restored on the reception side, the USB communication is not established.

Although it is necessary to convert data stored in the CRC object field, it is not necessary to convert the value of a field not subjected to CRC calculation, such as PID (Packet ID). Accordingly, the handshake packet not containing a CRC is not converted.

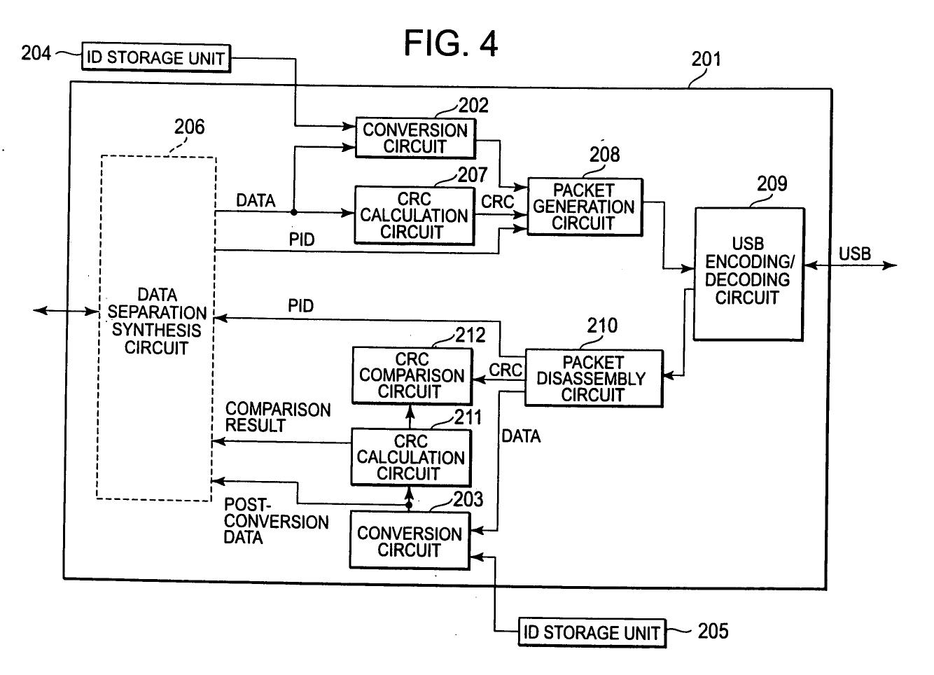

FIG. 4 is a block diagram showing the configuration of an SIE (Serial Interface Engine) for processing a USB packet in this example. The SIE 201 of FIG. 4 shows a schematic functional block of SIE (104,110) of FIG. 3. The SIE 201 has conversion circuits and generates a packet.

In general, respective data to be inputted from a USB host controller 103 to the SIE 104 and from a logic device 109 to the SIE 110 is separated into PID (Packet ID) and DATA (CRC object data). However, if inputted data is not separated, a data separation/synthesis circuit 206 separates the inputted data into PID and DATA.

An operation in which the SIE 201 generates a transmission packet from PID and DATA is as follows.

[1] A conversion circuit 202 converts DATA inputted to the SIE 201, using a value in an ID storage unit 204.
[2] A CRC calculation circuit 207 calculates a CRC of DATA inputted to the SIE 201.
[3] A packet generation circuit 208 generates a transmission packet based on PID inputted to the SIE 201, post-conversion data, and CRC.
[4] A USB encoding/decoding circuit 209 converts the transmission packet to USB bus format, and transmits it.

On the other hand, an operation for processing a reception packet is as follows.

[1] The USB encoding/decoding circuit 209 decodes a reception packet from USB bus format to SIE-processable format.
[2] A packet disassembly circuit 210 separates the reception packet into PID, DATA, and CRC.
[3] A conversion circuit 203 converts DATA separated from the reception packet, using a value in an ID storage unit 205.
[4] A CRC calculation circuit 211 calculates a CRC of post-conversion data.
[5] A CRC comparison circuit 212 compares the CRC of the post-conversion data and the CRC separated from the reception packet.
[6] The data separation/synthesis circuit 206 processes the reception packet in accordance with the comparison result. The data separation/synthesis circuit 206 processes the packet normally if the comparison result indicates a match, and discards the packet if the comparison result indicates a mismatch.

In FIG. 3, the conversion circuits 105 and 111 are disposed in the SIE (104,110) respectively. However, the conversion circuit 105 or 111 may be disposed in either of the USB interface apparatuses 102 and 108, with a configuration for generating a packet containing the CRCs of the post-conversion data and the pre-conversion data. Further, the conversion circuits 202 and 203 may have any circuit configuration that enables data converted on the transmission side to be restored on the reception side using values in the ID storage units 204 and 205 respectively.

The conversion circuits 202 and 203 may be XOR circuits as an example. In this case, the conversion circuit 202 stores a value obtained by XORing CRC object data and a value in the ID storage unit 204 into the CRC object field of a transmission packet. Further, the conversion circuits 202 and 203 may be encryption circuits using a common key such as DES or AES. In this case, the conversion circuits 202 and 203 store CRC object data encrypted using a value in the ID storage unit 204 as a common key into the CRC object field of a transmission packet.

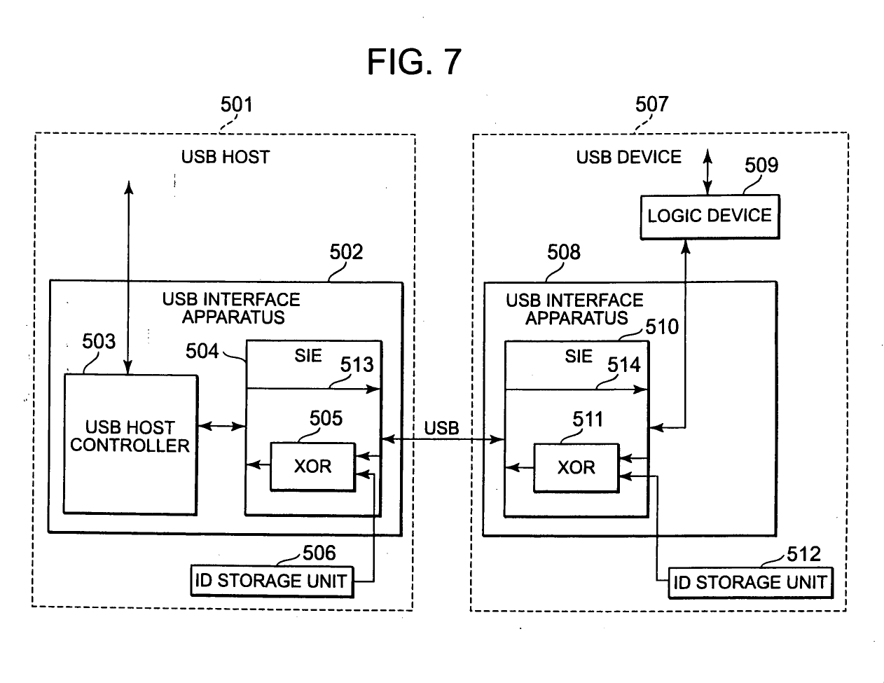

In Particular, the configuration in which the conversion circuits 202 and 203 are XOR circuits is a simple circuit configuration. Configurations in which XOR circuits are disposed in the module of the SIE 201 will be described in Examples 2 to 4. However, the illustration of the function block of FIG. 4 is omitted in FIGS. 7, 9, and 12.

In this example, in order to achieve the USB security function, conversion is performed on data to be stored in the CRC object field of a packet to be transmitted/received instead of the addition of the authentication phase as in the conventional technique. Therefore, data processing by upper software of the USB interface is the same as the standard USB processing flow. That is, it is not necessary to add the software for implementing the security function as in the conventional technique, but the security function can be achieved based only on the standard USB software.

In this example, it is necessary to add the conversion circuits for transmission data to the USB interface apparatuses. With the configuration in which the conversion circuits are XOR circuits as an example, transmission data can be converted with a simple circuit configuration.

### Example 2

Example 2 of this invention will be described with reference to drawings. In this example, only data in the direction from a USB device to a USB host (hereinafter referred to as “IN direction”) is subjected to conversion. FIG. 7 is a block diagram showing the configuration of USB interface apparatuses according to this example.

Referring to FIG. 7, in a USB host 501, an XOR circuit 505 is disposed such that data obtained by XORing data from a USB device 507 and a value in an ID storage unit 506 is transferred to a USB host controller 503. In the USB device 507, an XOR circuit 511 is disposed such that data obtained by XORing data to be transmitted to the USB host 501 and a value in an ID storage unit 512 is transmitted to the USB host 501.

In the configuration shown in FIG. 7, only data in the IN direction is subjected to conversion, which produces the advantageous effect of mainly improving the security of the USB device 507. For example, in the case where the USB host 501 that does not know an ID (i.e., unauthorized USB host) tries to fraudulently acquire data stored in the USB device 507, an ID mismatch does not allow USB communication to be established, which can prevent the USB host 501 from fraudulently acquiring the data.

### Operation

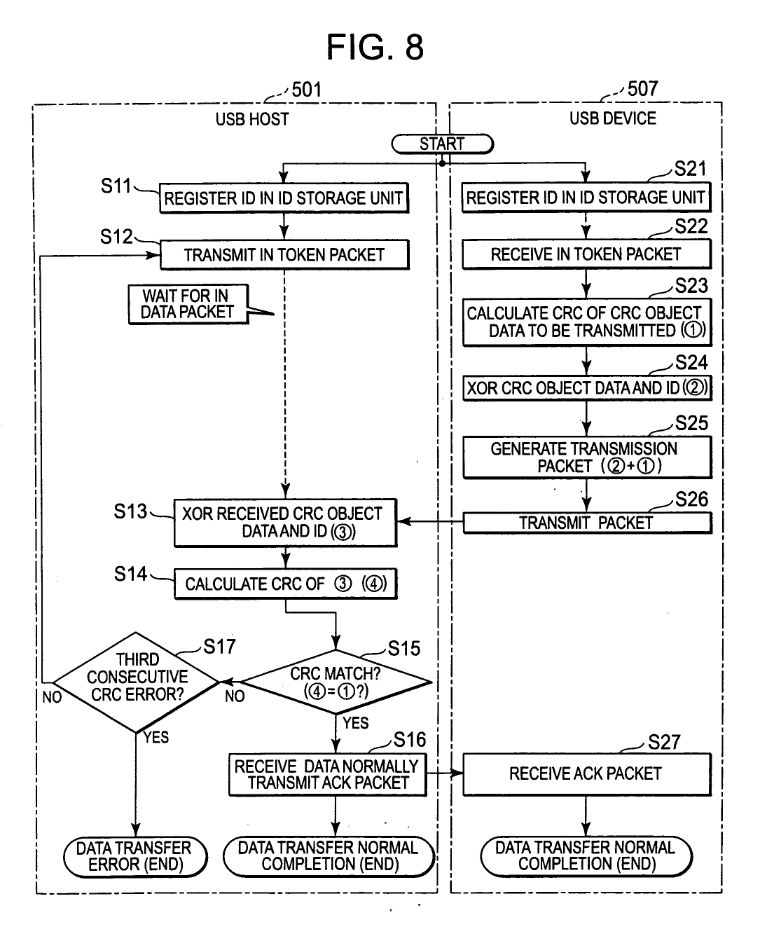

FIG. 8 is a flowchart of IN-direction USB transaction processing by USB interface apparatuses 502 and 508 according to this example. Specific operations of the USB interface apparatuses 502 and 508 according to this example will be described below. The operations will be described by way of example in which transmission data is 11110000 and the value (ID) in the ID storage Units 506 and 512 is 10101010.

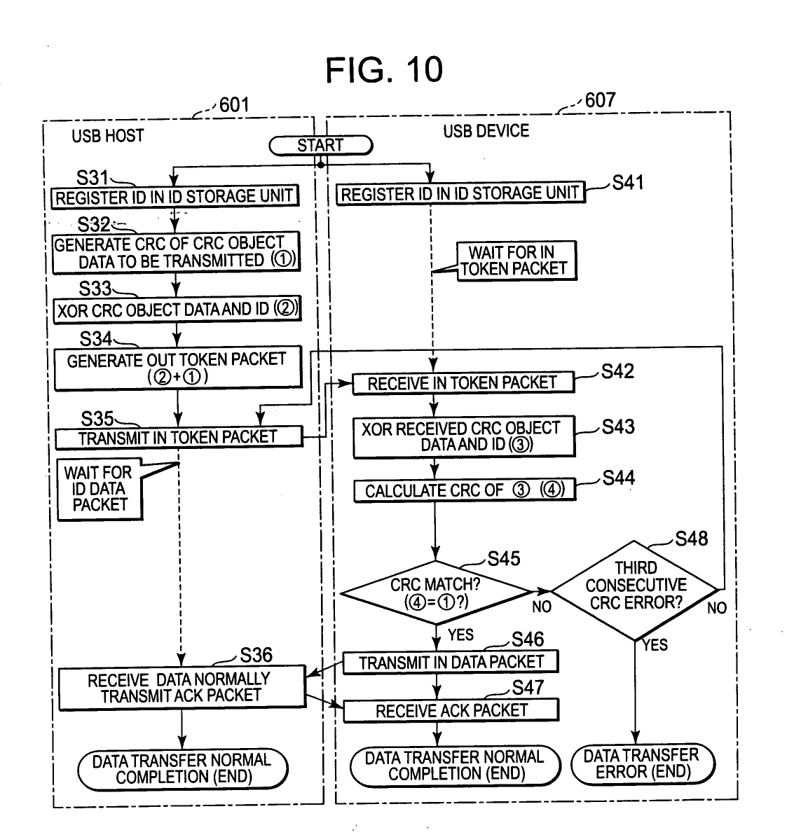

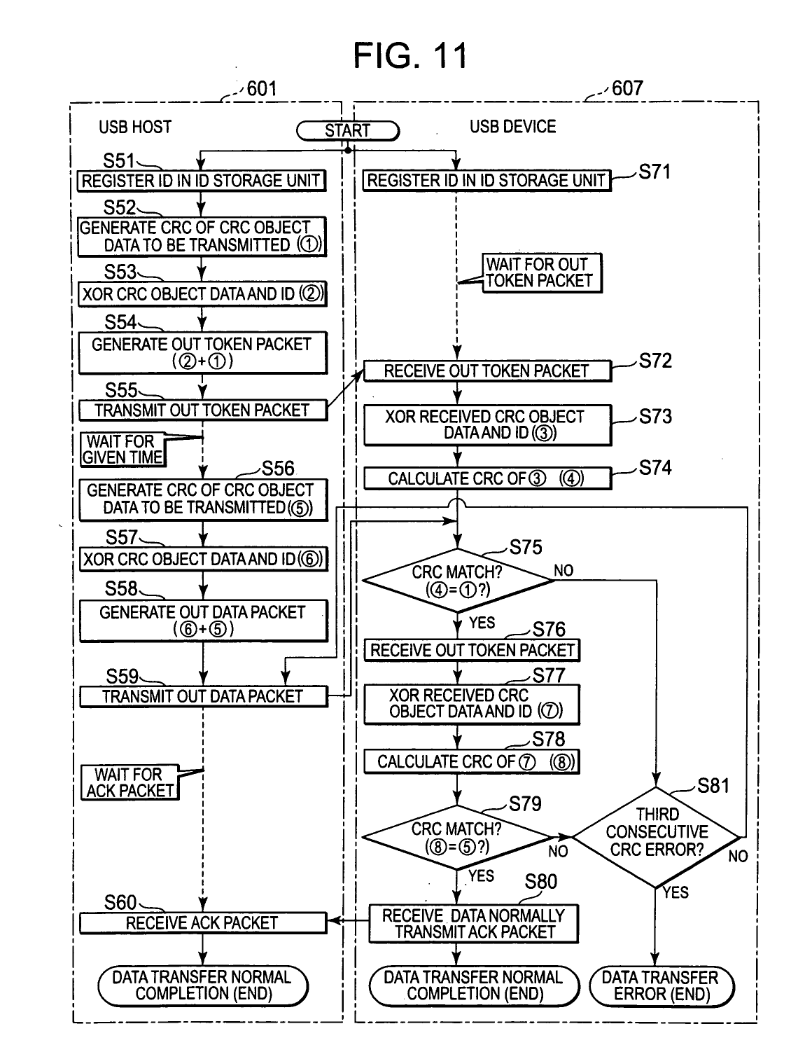

In the flowchart of FIG. 8, the illustration of the following processing is omitted for simplicity (the same applies to FIGS. 10 and 11).
Processing from connection recognition of the USB device to USB speed determination
Processing of errors other than a CRC error
CRC recalculation and CRC check of packets other than a packet having converted CRC object data
PING flow performed in OUT transfer in HS (High Speed) mode
Transmission of handshake packets other than ACK and associated processing

FIG. 8 is a flowchart of IN-direction USB transaction processing by USB interface apparatuses 502 and 508 (i.e., apparatuses in which only IN-direction data is subjected to conversion) according to this example. In OUT-direction USB transaction processing, a packet transmitted from the USB device 507 to the USB host 501 is only a handshake packet; therefore, data conversion by the XOR circuits 505 and 511 is not performed. That is, the processing is the same as the standard USB transaction flow; accordingly, the processing of such a packet is omitted in FIG. 8.

Referring to FIGS. 7 and 8,

[1] A common value is registered in the ID storage unit 506 of the USB host 501 and the ID storage unit 512 of the USB device 507 (step S11, step S21).
[2] In the case of OUT-direction data, in the USB host 501, CRC object data is not XORed in an SIE 504, but passes through a path 513. Therefore, “11110000” is stored in the CRC object field of a packet on a USB bus, and a CRC calculated from “11110000” is appended to the packet.
[3] In the USB device 507, the CRC object data of the received packet is not XORed in an SIE 510, but passes through a path 514. Therefore, a CRC is recalculated from the CRC object data “11110000”. If the recalculated CRC matches the CRC appended to the reception packet, the packet is received normally and processed.
[4] In the case of IN-direction data, in the USB device 507, a CRC of CRC object data to be transmitted to the host is calculated (step S23).
[5] After the CRC is calculated, the CRC object data “11110000” to be transmitted and the value “10101010” in the ID storage unit 512 are XORed (step S24).
[6] The USB device 507 stores post-XOR data “01011010” in the CRC object field, generates a packet with the CRC of the pre-conversion data “11110000” appended thereto (step S25), and transmits it to the USB host 501 (step S26).
[7] In the USB host 501, the CRC object data “01011010” of the received packet and the value “10101010” in the ID storage unit 506 are XORed (step S13).
[8] A CRC is recalculated from post-XOR data “11110000” (step S14). If the recalculated CRC matches the CRC appended to the reception packet (Yes in step S15), the packet is received normally and processed (step S16). On the other hand, if the USB host 501 uses an ID different from that of the USB device 507, a mismatch occurs in CRC check (No in step S15), so that the packet is discarded.

For example, if the value in the ID storage unit 506 of the USB host 501 is “11111111”, post-XOR data in the USB host 501 is “10100101”. A recalculated CRC is the CRC of “10100101”, and therefore does not match the CRC appended to the reception packet.

In the flowchart of FIG. 8, steps S11, S21, S24, and S13 are not included in the standard USB transaction processing flow. In the case where steps S11 and S21 are implemented by software, special software is required. However, these steps are independent of USB descriptor processing; therefore, the change of the standard USB software such as the driver is not required. Further, since steps S24 and S13 are implemented by adding the function to the USB interface apparatuses 502 and 508 (hardware), the standard USB software does not intervene to process these steps. To process step S25, since the combination of the CRC object data and the CRC differs from the standard USB packet configuration, the circuit configuration shown in FIG. 4 is required. However, the standard USB software does not intervene to process step S25. The other steps in FIG. 8 are the same as the standard USB transaction processing flow.

Therefore, according to this example, USB transactions having the security function can be performed with only the standard USB software and the software independent of USB descriptor processing. That is, by changing the configuration of the USB packet instead of adding the authentication function, the USB security function can be achieved based only on the addition of the simple circuits and the standard software.

### Example 3

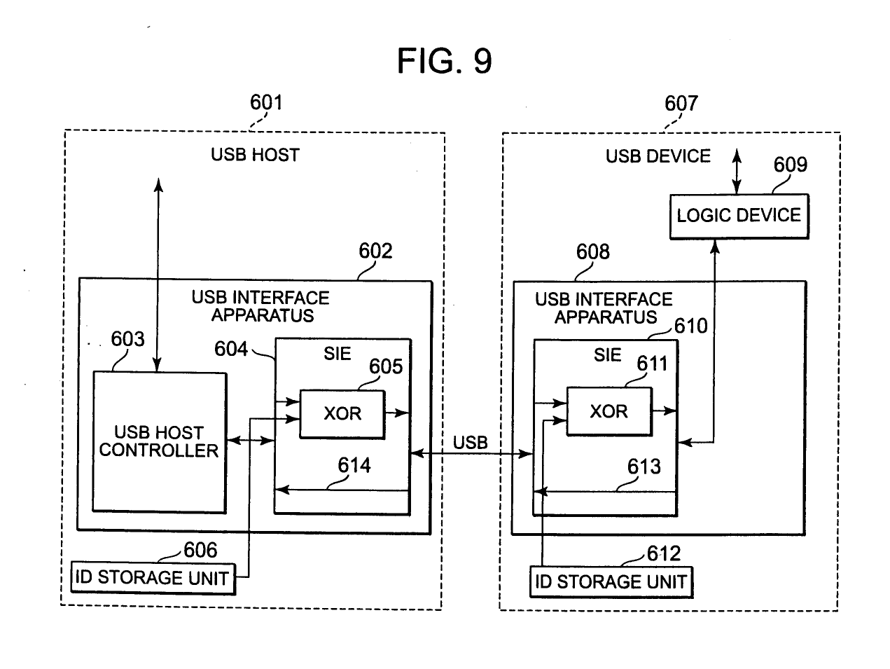

Example 3 of this invention will be described with reference to drawings. In this example, only data in the direction from a USB host to a USB device (OUT direction) is subjected to conversion. FIG. 9 is a block diagram showing the configuration of USB interface apparatuses according to this example.

Referring to FIG. 9, in a USB host 601, an XOR circuit 605 is disposed such that data obtained by XORing data to be transmitted to a USB device 607 and a value in an ID storage unit 606 is transmitted to the USB device 607. In the USB device 607, an XOR circuit 611 is disposed such that data obtained by XORing data from the USB host 601 and a value in an ID storage unit 612 is transferred to a logic device 609.

In the configuration shown in FIG. 9, only data in the OUT direction is subjected to conversion, which produces the advantageous effect of mainly improving the security of the USB host 601. For example, assume that a fraudulent program (e.g., USB virus) which is automatically executed in the USB device 607 that does not know an ID (i.e., unauthorized USB device) is stored. Even if the device is connected to the USB host, a token packet transmitted from the USB host is converted by the conversion circuit, so that USB communication is not established without an ID match, which can prevent the execution of the fraudulent program.

### Operation

FIG. 10 is a flowchart of IN-direction USB transaction processing by USB interface apparatuses 602 and 608 according to this example. Specific operations of the USB interface apparatuses 602 and 608 according to this example will be described below. The operations will be described by way of example in which transmission data is 11110000 and the value (ID) in the ID storage units 606 and 612 is 10101010.

Referring to FIGS. 9 and 10,

[1] A common value is registered in the ID storage unit 606 of the USB host 601 and the ID storage unit 612 of the USB device 607 (step S31, step S41).
[2] In the case of OUT-direction data, in the USB host 601, a CRC of CRC object data to be transmitted to the USB device 607 is calculated (step S32).
[3] After the CRC is calculated, the CRC object data “11110000” to be transmitted and the value “10101010” in the ID storage unit 606 are XORed (step S33).
[4] The USB host 601 stores post-XOR data “01011010” in the CRC object field, generates a packet with the CRC of the pre-conversion data “11110000” appended thereto (step S34), and transmits it to the USB device 607 (step S35).
[5] In the USB device 607, the CRC object data “01011010” of the received packet and the value “10101010” in the ID storage unit 612 are XORed (step S43).
[6] A CRC is recalculated from post-XOR data “11110000” (step S44). If the recalculated CRC matches the CRC appended to the reception packet (Yes in step S45), the packet is received normally and processed. On the other hand, if the USB device 607 uses an ID different from that of the USB host 601, a mismatch occurs in CRC check (No in step S45), so that the packet is discarded.
[7] In the case of IN-direction data, in the USB device 607, CRC object data is not XORed in an SIE 610, but passes through a path 613. Therefore, “11110000” is stored in the CRC object field of a packet on a USB bus, and a CRC calculated from “11110000” is appended to the packet.
[8] In the USB host 601, the CRC object data of the received packet is not XORed in an SIE 604, but passes through a path 614. Therefore, a CRC is recalculated from the CRC object data “11110000”. If the recalculated CRC matches the CRC appended to the reception packet, the packet is received normally and processed.

FIG. 11 is a flowchart of OUT-direction USB transaction processing by the USB interface apparatuses 602 and 608 according to this example. In FIG. 11, both a token packet and a data packet are converted by the XOR circuits 605 and 611.

In the flowcharts of FIGS. 10 and 11, steps S31, S41, S33, and S43 in FIG. 10 and steps S51, S71, S53, S73, S57 and S77 in FIG. 11 are not included in the standard USB transaction flow. In the case where steps S31, S41, S51, and S71 are implemented by software, special software is required. However, these steps are independent of USB descriptor processing; therefore, the change of the standard USB software such as the driver is not required. Further, since steps S33, S43, S53, S73, S57, and S77 are implemented by adding the function to the USB interface apparatuses 602 and 608 (hardware), the standard USB software does not intervene to process these steps. To process steps S34, S54, and S58, since the combination of the CRC object data and the CRC differs from the standard USB packet configuration, the circuit configuration shown in FIG. 4 is required. However, the standard USB software does not intervene to process these steps. The other steps in FIGS. 10 and 11 are the same as the standard USB transaction processing flow.

Therefore, according to this example, USB transactions having the security function can be performed with only the standard USB software and the software independent of USB descriptor processing.

### Example 4

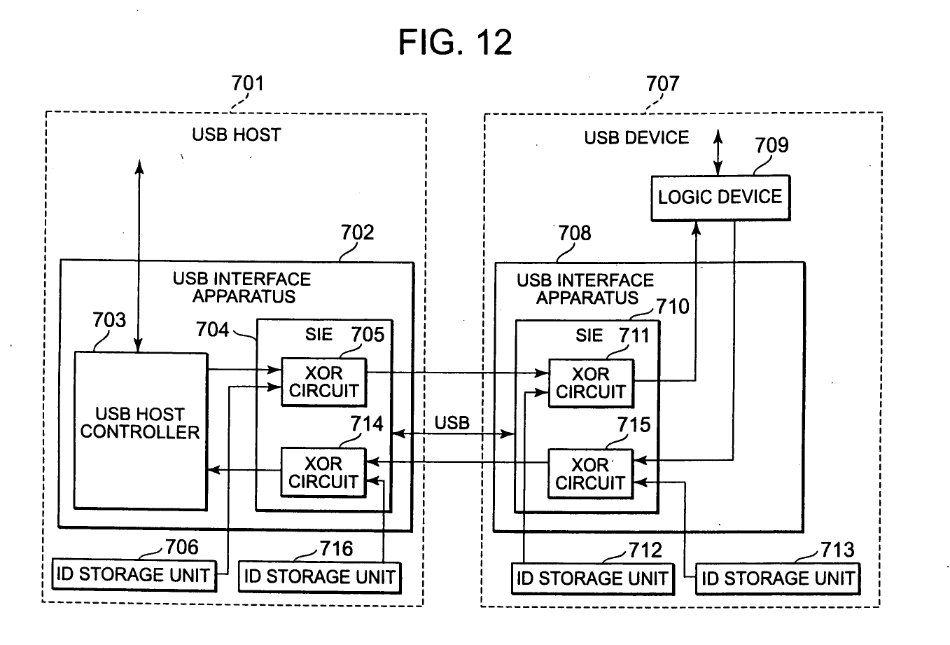

Example 4 of this invention will be described with reference to a drawing. In this example, data in both the IN direction and the OUT direction is subjected to conversion. FIG. 12 is a block diagram showing the configuration of USB interface apparatuses according to this example.

Referring to FIG. 12, in the USB interface apparatuses 702 and 708 according to this example, XOR circuits 714 and 715 for IN-direction data and XOR circuits 705 and 711 for OUT-direction data are provided separately. Further, ID storage units 713 and 716 for the IN direction and ID storage units 706 and 712 for the OUT direction are provided separately. This can enhance the security strength, compared to Example 2 (FIG. 7) and Example 3 (FIG. 9). The security strength depends on the ID bit length. In the case of using an n-bit ID, the security strength is 2 raised to the n-th power times that of Examples 2 and 3.

Although the description has been made based on the examples, the invention is not limited to the above examples.

1. A USB interface apparatus provided in electronic equipment on a USB packet transmission side, the USB interface apparatus comprising:
a conversion unit for converting CRC object data which is data contained in a field subjected to CRC calculation in a USB packet, based on a predetermined rule corresponding to reverse conversion of conversion to be performed on the CRC object data by destination electronic equipment;
a CRC calculation unit for calculating a CRC of CRC object data obtained before conversion by the conversion unit; and
a packet generation unit for generating a USB packet containing data converted by the conversion unit and the CRC calculated by the CRC calculation unit.

2. A USB interface apparatus provided in electronic equipment on a USB packet reception side, the USB interface apparatus comprising:
an extraction unit for extracting CRC object data which is data contained in a field subjected to CRC calculation in a USB packet and a CRC from the USB packet;
a conversion unit for converting the CRC object data extracted by the extraction unit, based on a predetermined rule corresponding to reverse conversion of conversion performed on the CRC object data by source electronic equipment;
a CRC calculation unit for calculating a CRC of CRC object data obtained after conversion by the conversion unit; and
a comparison unit for comparing the CRC extracted by the extraction unit and the CRC calculated by the CRC calculation unit.

3. The USB interface apparatus according to claim 1, wherein conversion by the conversion unit based on the predetermined rule is performed using predetermined data shared between the source device and the destination device.

4. The USB interface apparatus according to claim 3, wherein the predetermined data comprises a predetermined bit string, and the predetermined rule comprises an exclusive OR operation performed on a bit-by-bit basis between the predetermined bit string and the CRC object data.

5. The USB interface apparatus according to claim 3, wherein the predetermined data comprises a common key of a common key encryption, and the predetermined rule is encryption or decode of the CRC object data on the basis of the common key.

6. The USB interface apparatus according to claim 1, the USB interface apparatus further comprising a storage unit for storing the predetermined data.

7. The USB interface apparatus according to claim 1, wherein the USB packet comprises a token packet or a data packet in USB communication.

8. Electronic equipment comprising the USB interface apparatus according to claim 1.

9. A USB communication system apparatus comprising a plurality of the electronic equipment according to claim 8.

10. A USB packet transmitting method comprising:
converting CRC object data which is data contained in a field subjected to CRC calculation in a USB packet, based on a predetermined rule corresponding to reverse conversion to be performed on the CRC object data by destination electronic equipment;
calculating a CRC of CRC object data obtained before conversion in the conversion; and
generating and transmitting a USB packet containing data converted in the conversion and the CRC calculated in the CRC calculation.

11. A USB packet receiving method comprising:
receiving a USB packet;
extracting CRC object data which is data contained in a field subjected to CRC calculation in the received USB packet and a CRC from the USB packet;
converting the CRC object data extracted in the extraction, based on a predetermined rule corresponding to reverse conversion of conversion performed on the CRC object data by source electronic equipment;
calculating a CRC of CRC object data obtained after conversion in the conversion; and
comparing the CRC extracted in the extraction and the CRC calculated in the CRC calculation.

12. A USB packet communication method comprising each step in a USB packet transmitting method comprising converting CRC object data which is data contained in a field subjected to CRC calculation in a USB packet, based on a predetermined rule corresponding to reverse conversion of conversion to be performed on the CRC object data by destination electronic equipment; calculating a CRC of CRC object data obtained before conversion in the conversion; and generating and transmitting a USB packet containing data converted in the conversion step and the CRC calculated in the CRC calculation and each step in the USB packet receiving method according to claim 11.
